(19) United States
(12) Patent Application Publication
(10) Pub. No.: US 2003/0210367 A1
(43) Pub. Date: Nov. 13, 2003

(54) Reflection-type liquid-crystal display, and optical film

(75) Inventors: Yuuki Nakano, Ibaraki-shi (JP); Toshihiko Ariyoshi, Ibaraki-shi (JP); Seiji Umemoto, Ibaraki-shi (JP); Ryoji Kinoshita, Ibaraki-shi (JP)

Correspondence Address: SUGHRUE MION, PLLC, 2100 PENNSYLVANIA AVENUE, N.W., WASHINGTON, DC, 20037, US

(73) Assignee: NITTO DENKO CORPORATION

(21) Appl. No.: 10/430,268

(22) Filed: May 7, 2003

(30) Foreign Application Priority Data
May 7, 2002 (JP) P2002-131305

(51) Int. Cl. G02F 1/1335

(52) U.S. Cl. 349/113; 349/63

(57) ABSTRACT

A reflection-type liquid-crystal display with a reflection-type liquid-crystal display panel, which comprises a transparent view-side substrate with a transparent electrode and a transparent backside substrate with a transparent electrode that are so combined as to have a liquid crystal between the facing electrodes thereof to construct a liquid-crystal cell, and comprises a transparent optical film having a radius of curvature at break of at most 5 mm, on the outer side of the view-side substrate via a polarizing layer therebetween, and a reflection layer on the outer side of the backside substrate, and which is characterized in that the optical film has, in its surface, a plurality of optical path-changing slopes that incline at an angle of from 35 to 48 degrees relative to the standard plane of the view-side substrate, and one or more sides of the optical film have a light source; and the optical film.

The present application is based on Japanese Patent Application No. 2002-131305, which is incorporated herein by reference.

### BACKGROUND OF THE INVENTION

1. Field of the Invention

The present invention relates to a thin and lightweight reflection-type liquid-crystal display for use both in external light and in illumination, and to an optical film favorable to it.

2. Description of the Related Art

For reflection-type liquid-crystal displays for use both in external light and in illumination, which are for mobiles equipped with a lighting mechanism for making it possible to display images even in the dark such as in the nighttime, heretofore known are front light-type ones in which a sidelight-type light pipe is fitted to the view-side substrate of a liquid-crystal cell by the use of a UV-curable resin (Unexamined Japanese Patent Publication No. Hei. 10-268308).

However, a lot of time is taken for fitting the light pipe to the view-side substrate, and the efficiency in producing the devices is poor. Another problem with the devices is that, since bubbles and others enter the bonding interface while fabricating them, the cell substrate is often damaged or broken when it is peeled for reworking the devices and the productivity of the devices is low. Still another problem is that the devices are bulky and heavyweight owing to the thickness and the weight of the light pipe therein.

### SUMMARY OF THE INVENTION

An object of the invention is to develop a thin and lightweight reflection-type liquid-crystal display for use both in external light and in illumination, in which the cell substrate is damaged or broken little in peeling it for reworking the lighting mechanism.

The invention provides a reflection-type liquid-crystal display with a reflection-type liquid-crystal display panel, which comprises a transparent view-side substrate with a transparent electrode and a transparent backside substrate with a transparent electrode that are so combined as to have a liquid crystal between the facing electrodes thereof to construct a liquid-crystal cell, and comprises a transparent optical film having a radius of curvature at break of at most 5 mm, on the outer side of the view-side substrate via a polarizing layer therebetween, and a reflection layer on the outer side of the backside substrate, and which is characterized in that the optical film has, in its surface, a plurality of optical path-changing slopes that incline at an angle of from 35 to 48 degrees relative to the standard plane of the view-side substrate, and one or more sides of the optical film have a light source. The invention also provides the optical film.

According to the invention, the optical film to form the lighting mechanism is flexible and is hardly damaged or broken when it is attached to the substrate while curved or deformed, and, in addition, few bubbles enter the interface between the film and the substrate to reduce the frequency of reworking. Moreover, it is easy to continuously adhere the optical film to liquid-crystal cells, and its workability, productivity and production efficiency are all good. Further, the optical film is well workable in reworking, and the cell substrate is damaged or broken little when the optical film is peeled off from it. In addition, it is easy to thin the optical film. Accordingly, the invention makes it possible to readily fabricate a thin and lightweight reflection-type liquid-crystal display for use both in external light and in illumination.

The lighting mechanism is a front light that comprises the optical film and the light source disposed on the side of the film. The path of the light that travels inside the optical film is well changed with good orientation toward the backside of the cell via the optical path-changing slopes of the film, and is reflected on the reflection layer on the backside of the device. The reflected light passes through the cell to attain liquid-crystal display. In this case, when a low-refractive-index layer is provided on the back of the optical film adhering to the cell, then the light transmittance through the film may be efficiently enclosed and, while the absorption attenuation by the polarizing layer and others is prevented, the light from the light source may be efficiently transmitted toward the opposite side to attain bright display.

### BRIEF DESCRIPTION OF THE DRAWINGS

In the accompanying drawings:

FIG. 1 shows a cross-sectional view of one embodiment of the invention; and

FIGS. 2A to 2E show cross-sectional views showing various types of light-emitting means of the optical film for use in the invention.

### DETAILED DESCRIPTION OF THE PREFERRED EMBODIMENTS

The reflection-type liquid-crystal display of the invention has a reflection-type liquid-crystal display panel, which comprises a transparent view-side substrate with a transparent electrode and a transparent backside substrate with a transparent electrode that are so combined as to have a liquid crystal between the facing electrodes thereof to construct a liquid-crystal cell, and comprises a transparent optical film having a radius of curvature at break of at most 5 mm, on the outer side of the view-side substrate via a polarizing layer therebetween, and a reflection layer on the outer side of the backside substrate, and which is characterized in that the optical film has, in its surface, a plurality of optical path-changing slopes that incline at an angle of from 35 to 48 degrees relative to the standard plane of the view-side substrate, and one or more sides of the optical film have a light source.

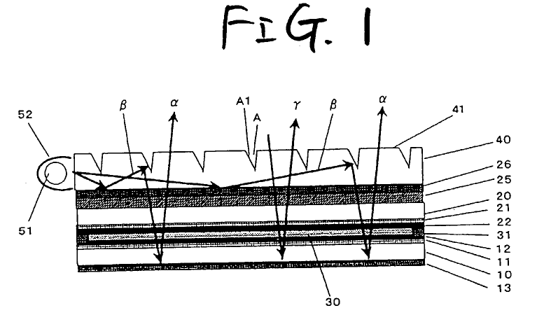

One embodiment of the reflection-type liquid-crystal display is shown in FIG. 1. 10 is a backside substrate; 11 is a transparent electrode; 13 is a reflection layer. 20 is a view-side substrate; 21 is a transparent electrode; 25 is a polarizing layer; 30 is a liquid crystal; 40 is an optical film; A1 is an optical path-changing slope; and 51 is a light source. 12 and 22 each are an orientation film; and 26 is a low-refractive-index transparent layer.

In the liquid-crystal display panel, the transparent substrates 10 and 20 each have the transparent electrodes 11 and 21, respectively, and these view-side and backside substrates (10, 20) are so combined that their electrodes face each other and have the liquid crystal 30 therebetween to construct a liquid-crystal cell, as illustrated. Thus constructed, the display panel has the transparent optical film 40 on the outer side of the view-side substrate via the polarizing layer 25 therebetween, and at least has the reflection layer 13 on the outer side of the backside substrate. In this, the light having entered the optical film 40 on the view side is reflected and reversed on the reflection layer 13, while controlled by the liquid crystal 30 and others to be a display light, and this goes out the panel through the view side thereof. Having the reflection-type structure of this sort, the display panel is not specifically defined. In the drawing, 31 is a sealant for sealing up the liquid crystal 30 between the substrates 20 and 10.

Examples of the liquid-crystal cell are TN liquid-crystal cells, STN liquid-crystal cells, vertical orientation cells, HAN cells and OCB cells that are grouped depending on the orientation condition of liquid crystal molecules. They are twisted cells or non-twisted cells, guest-host cells, ferroelectric liquid-crystal cells, and those to be driven through light diffusion, etc. Regarding the driving system of the liquid-crystal cells, any of active matrix systems or passive matrix systems are employable herein. In general, the liquid crystal is driven via the transparent electrodes 21 and 11 provided inside the pair of cell substrates 20 and 10, as illustrated.

The view-side substrate and the backside substrate are transparent substrates that enable display light transmission therethrough. The transparent substrates maybe formed of any suitable material such as glass or resin. Especially preferred is an optically isotropic material that inhibits birefringence as much as possible to reduce light loss. Also preferred are non-alkali glass sheets of good colorlessness and transparency, and not blue glass sheets, as they increase the brightness and the display quality. Lightweight resin substrates are also preferred.

The thickness of the view-side and backside transparent substrates is not specifically defined, and may be suitably determined depending on the strength thereof for enclosing liquid crystal molecules between them. In general, the thickness may be from 10 μm to 5 mm, preferably from 50 μm to 2 mm, more preferably from 100 μm to 1 mm for thin and lightweight displays. The thickness of the view-side substrate may be the same as or different from that of the backside substrate. In particular, for improving the efficiency of light transmission to the optical path-changing slopes of the optical film, the thickness of the view-side substrate may partly vary, for example, having a wedge profile in cross-section for inclined disposition of the optical film thereon.

The plane dimension of the view-side substrate may be the same as or different from that of the backside substrate. It is desirable that at least the side of the view-side substrate on which the light source 51 is disposed protrudes outside as compared with the side of the backside substrate for easy fitting of the light source to the view-side substrate.

The function of the optical film 40 that is disposed outside the view-side substrate 20 via the polarizing layer 25 is described. The optical film 40 receives the light emitted by the light source 51 that is disposed on the side of the optical film 40, and the light then runs through the optical film 40 as the zigzagging arrow α therethrough, while the optical path of the light is changed toward the backside substrate of the panel via the optical path-changing slope A1 and the light is then reflected on the reflection layer 13 and reversed into illuminant light (display light), as in FIG. 1.

Having the function as above, the optical film 40 has optical path-changing slopes A1 that incline at an angle of from 35 to 48 degrees relative to the standard plane (virtual horizontal plane) of the view-side substrate, in order that they may reflect the light having entered the optical film 40 from the light source 51 to thereby change the optical path, as illustrated. In order that the panel could be thinned, the optical film has a plurality of such optical path-changing slopes. In that manner, the light having entered the optical film 40 from its side and running through it may be reflected on the slopes and the light traveling path can be well changed with good orientation.

Specifically, the optical film of a type of slope reflection essentially utilizes the light in the direction of regular reflection that shows a peak, and controls the optical path of the reflected light. Therefore, it readily realizes the light-traveling orientation advantageous to display, in particular, in the front direction, and attains a bright illumination mode. On the other hand, in an external light mode, the flat area except the slopes of the optical film can be utilized for display, and the panel may readily have a good balanced condition that is advantageous for both modes in external light and in illumination.

The optical film may be formed to have any shape except for the point that it should have a plurality of predetermined optical path-changing slopes mentioned above and a specific flexural characteristic. For obtaining the display light that is well oriented in the front direction via the optical path-changing mechanism, it is desirable that the optical film has a plurality of light-emitting means A1 with optical path-changing slopes A1 that face the side of the optical film on which the light source is disposed, or that is, the light incident surface of the optical film, more desirably the optical film has a plurality of such light-emitting means A with prismatically-formed, optical path-changing slopes A1.

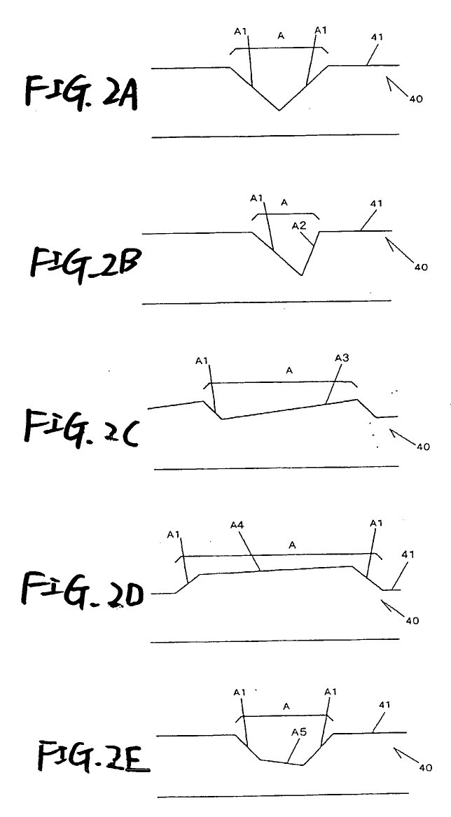

Examples of the above-mentioned optical path-changing slopes and the prismatically-formed light-emitting means are shown in FIG. 2A to FIG. 2E. In FIG. 2A to FIG. 2C, the light-emitting part A has a triangular cross section; and in FIG. 2D and FIG. 2E, it has a square cross section. In FIG. 2A, the light-emitting part A has an isosceles-triangular cross section to have two optical path-changing slopes A1; and in FIG. 2B, it has one optical path-changing slope A1 and another steep slope A2 of which the inclination angle relative to the standard plane is larger than that of the slope A1.

On the other hand, in FIG. 2C, a plurality of light-emitting means A, of which one unit is composed of one optical path-changing slope A1 and another gentle slope A3 having a small inclination angle relative to the standard plane, are continuously formed to be adjacent to each other entirely on one surface of the optical film. In FIG. 2D, the light-emitting part A has a protrusion (projection); and in FIG. 2E, the light-emitting part A has a recess form (groove).

Accordingly, as in the embodiments mentioned herein above, the light-emitting means may have a protrusion or recess form of which the slopes are equilateral sides or have the same inclination angle, or may also have a protrusion or recess form formed of one optical path-changing slope A1 and another steep or gentle slope. A2 or A3, or of slopes A4 and A5 that differ in the inclination angle. The inclination style of the light-emitting means may be suitably determined depending on the number and the position of the light incident surfaces of the optical film. For better scratch resistance to ensure the slope function of the optical film, it is desirable that the light-emitting means are in the form of recesses but not protrusions, like the illustrations given herein, since the slopes of the illustrated types are scratched little.

For attaining the preferable characteristic of the optical orientation in the front direction through the optical film as mentioned above, it is desirable that the optical path-changing slope A1 having an inclination angle of from 35 to 48 degrees relative to the standard plane faces the light-emitting side of the optical film and the cross-section profile of the light-emitting part A is triangular or pentagonal, like the illustrations given herein. Accordingly, when a light source is disposed on two or more sides of the optical film and when the optical film has two or more light incident surfaces, it is desirable that the optical path-changing slopes A1 of the optical film are formed in accordance with the number and the position of light sources and the light incident surfaces of the optical film.

In case where a light source is disposed on the opposite two sides of the optical film in one embodiment, the optical film 40 is preferably so designed that its light-emitting part A has two optical path-changing slopes A1 of which the cross-section profile has a form of an isosceles triangle, as in FIG. 2A; or its light-emitting part A has a cross-section profile of a trapezoid that comprises two optical path-changing slopes A1 of which the ridgelines run along the light incident surface of the optical film, as in FIG. 2D and FIG. 2E.

In case where a light source is disposed on two sides adjacent to each other in the vertical and horizontal directions, the optical film is preferably so designed that the ridgelines of the optical path-changing slopes A1 run along the two, vertical and horizontal directions of the film in accordance with that two adjacent sides of the film. In case where a light source is disposed on 3 or more sides including opposite sides or adjacent vertical and horizontal sides, the optical film is preferably so designed that it has any of the above-mentioned optical path-changing slopes A1 as combined in any desired manner. The above-mentioned, triangular to pentagonal cross-section profiles of the light-emitting means do not mean any strict polygons, and may be rounded or deformed in some degree within the range of acceptable production technology. Preferably, the cross-section profile of the light-emitting part is triangular, as the optical film of the type is easy to produce.

The optical path-changing slope A1 of the optical has a role of reflecting the light, which has entered the film from the light source to run through the film and has reached the slope, to thereby change the traveling direction of the thus-reflected light and send the light to the backside of the liquid-crystal display panel. In this case, the inclination angle of the optical path-changing slope A1 is defined to fall between 35 and 48 degrees relative to the standard plane, whereby the traveling direction of the light having entered the optical film via its side fade and running through the film may be favorably changed well vertically to the standard plane to give good display light of good orientation to the front side, as in FIG. 1 in which the traveling route of the light running through the optical film is designated by the zigzagging arrow α.

If the inclination angle is smaller than 35 degrees, the optical path of the light reflected on the reflection layer will be much shifted from the direction to the front side and could not be effectively utilized for display, and, as a result, the brightness in the front direction will lower. If, on the other hand, the angle is larger than 48 degrees, the light to enter the optical film from its side and to run through the film could not undergo total reflection and, as a result, the light that leaks from the optical path-changing slopes will increase, and, if so, the utilization efficiency of the light to enter the optical film from its side will be low.

For optical path change for better orientation to the front side and for better inhibition of light leakage, the inclination angle of the optical path-changing slope A1 is preferably from 38 to 45 degrees, more preferably from 40 to 44 degrees in consideration of the total reflection condition of the light that runs through the optical film based on the Snell's law of refraction. In one example, a general total reflection condition of an optical film having a refractive index of 1.5 is about 42 degrees. In this case, therefore, the light having entered the film runs inside the film while being focused to fall within a range of about ±42 degrees, and reaches the optical path-changing slope of the film.

A plurality of the light-emitting means A each equipped with the optical path-changing slopes A1 are formed as distributed in the surface of the optical film, for reducing the thickness of the optical film as so mentioned hereinabove. In this case, the optical film 40 is preferably so designed that it has a gentle slope A3 or A4 having an inclination angle of at most 10 degrees, more preferably at most 5 degrees, even more preferably from 0 to 3 degrees relative to the standard plane, or has a flat plane 41 having an inclination angle of about 0 degree relative to the optical film 40, as in the illustrations of FIG. 2, in order that the light having entered the optical film through the light-emitting face thereof may be reflected backward so as to be efficiently transmitted toward the opposite side face and the overall face of the liquid-crystal display panel can therefore emit light as uniformly as possible.

Accordingly in the light-emitting part A that includes the steep slope A2 illustrated in FIG. 2B, the angle of the steep slope is preferably at least 50 degrees, more preferably at least 60 degrees, even more preferably from 70 to 90 degrees so that the width of the flat face 41 could be broadened. The gentle slopes A3 and A4 and the flat face 41 mentioned above function as a part through which the display light α in an illumination mode goes out, apart through which external light enters the panel in an external light mode, and a part through which the reflected display light γ from the reflection layer 13 goes out, as in FIG. 1. Via these parts, the reflection-type liquid-crystal display of the invention acts to display images both in external light and in illumination.

In the above-mentioned case especially having the continuous light-emitting means A that are composed of the neighboring slopes A1 and A4 as in FIG. 2C, it is desirable that the angle difference between the inclination angle of the gentle slope A3 and the standard plane is at most 5 degrees, more preferably from 0.01 to 4 degrees, even more preferably from 0.1 to 3 degrees in the entire optical film; and it is more desirable that the inclination angle difference between the nearest slopes is at most 1 degree, more preferably at most 0.3 degree, even more preferably from 0.001 to 0.1 degree. This is in order that the light transmission through the gentle slopes A3 does not cause any significant change in the optimum visible direction, especially the optimum visible direction in around the front direction of the reflection-type liquid-crystal display, and in particular, in order that the optimum visible direction of the device does not significantly vary between the nearest gentle slopes.

For obtaining bright display in the external light mode of the device, the projected area of the gentle slope A3 relative on the standard plane is preferably at least 5 times, more preferably at least 10 times, even more preferably from 15 to 100 times that of the optical path-changing slope A1. This is for the purpose of increasing the external light incident efficiency and increasing the transmission efficiency of the display light reflected on the reflection layer. The same shall apply also to the case of the light-emitting part A with slopes A1 and A4 as in FIG. 2D.

Preferably, the light-emitting means A are so formed that their ridgelines run in parallel or obliquely to the light incident surface of the optical film having the light source 51 disposed thereon for better efficiency of light acceptance through the side and light transmission in the optical film and for higher brightness of the device. For this, the light-emitting means A may be formed continuously and entirely from one side to the other side of the optical film, or may be discontinuously and intermittently formed.

In case where the light-emitting means are formed discontinuously, it is desirable that the length in the direction of the light incident surface of the groove or protrusion that forms the part is at least 5 times, more preferably at least 10 times, even more preferably at least from 15 to 100 times the depth or the height of the groove or protrusion, for better transmission light incident efficiency and better optical path-changing efficiency. Also preferably, the length is at most 500 μm, more preferably from 10 to 300 μm, even more preferably from 20 to 150 μm, for better uniformity of light emission through the panel display plane. The length is based on the major side direction of the optical path-changing slope.

The cross-section profile of the light-emitting part A and the pitch of the optical path-changing slopes A1 to form the part are not specifically defined. Since the optical path-changing slope A1 is a brightness determinant factor in the illumination mode of the device, the profile and the pitch may be suitably determined in consideration of the emission uniformity in the panel display plane in the illumination mode or the external light mode of the device, and the optical path-changing degree can be controlled by controlling the distribution density of the optical path-changing slopes.

Accordingly, the inclination angle of the slopes A1 to A5 may be the same wholly on the entire surface of the optical film; or the light-emitting means A may be enlarged toward the direction remoter from the light incident surface, for the purpose of unifying the light emission from the display panel in consideration of the absorption loss and the transmission attenuation through the optical path change in the device; or the light-emitting means A may be formed at a constant pitch; or the pitch of the parts A may be narrowed toward the direction remoter from the light incident surface to thereby increase the distribution density of the light-emitting means A; or the parts A may be formed at random pitches for unifying the light emission from the display panel.

In case where the light-emitting means A are discontinuous grooves or protrusions, the size, the shape, the distribution density and the direction of the ridgelines of the grooves or protrusions may be made irregular or such irregular or regular or uniform grooves or protrusions may be disposed at random to thereby unify the light emission from the display panel. Further, the position of the light source of a point light source is made a virtual center, and the light-emitting means A may be pitch-wise (concentrically) disposed around the virtual center. Accordingly as in the embodiments mentioned hereinabove, the uniformity of the light emission from the display panel can be attained by applying a suitable system to the light-emitting means A.

When the optical path-changing slope A1 overlaps with the pixel of liquid-crystal cell, then the display will be unnatural owing to the display light transmission insufficiency. To overcome the problem, it is desirable that the overlapping area is reduced as much as possible to thereby ensure satisfactory light transmissivity via the gentle slopes A3 and the flat faces 41.

From the above-mentioned point and considering that the pixel pitch of liquid crystal cell is generally from 100 to 300 μm, it is desirable that the projected width of the optical path-changing slope A1 is at most 40 μm, more preferably from 1 to 20 μm, even more preferably from 2 to 15 μm based on the projected width on the reference plane. The projected width falling within the range is preferred for preventing the display quality from being worsened by diffraction, in view of the fact that the coherent length of ordinary fluorescent tubes is about 20 μm.

Also in view of the above-mentioned point, the distance between the optical path-changing slopes A1 is preferably larger. On the other hand, however, the optical path-changing slopes are functional parts for substantial illumination light formation through optical path conversion of the light having entered the device through the side face thereof, as so mentioned hereinabove. Therefore, if the distance between the optical path-changing slopes A1 is too broad, the illumination in lighting-on will be sparse to produce unnatural display. Taking these into consideration, it is desirable that the pitch of the optical path-changing slopes A1 is at most 5 mm, more preferably from 5 pin to 3 mm, more preferably from 10 μm to 2 mm.

Especially when the prismatically-formed light-emitting means have stripe-like continuous grooves, they will interfere with the pixels of liquid crystal cell to give moire. Moire may be prevented by controlling the pitch of the light-emitting means. However, as so mentioned hereinabove, the pitch has a preferred range. Accordingly, the problem is how to prevent moire within the preferred pitch range.

For preventing the moire in the invention, it is desirable that the ridgelines of the grooves and the protrusions are inclined relative to the light incident surface of the device in such a manner that the grooves and the protrusions could be aligned to cross the pixels. In that case, if the inclination angle of the optical path-changing slopes A1 relative to the light incident surface of the device is too large, then the reflection via the slopes will be deflected and the direction of the changed optical path may be thereby significantly deflected to worsen the display quality.

Accordingly, the inclination angle of the ridgeline relative to the light incident surface of the device is preferably within ±30 degrees, more preferably within ±25 degrees. The symbol ± indicates the inclination direction of the ridgeline based on the light incident surface of the device. When no moire is formed owing to low resolution of liquid-crystal cell or when moire is ignorable, it is desirable that the ridgelines are more parallel to each other. A system of dispersion and distribution of discontinuous light-emitting means, and a system of irregular dispersion and distribution thereof are also preferred for moire prevention.

The optical film may be formed of any suitable material which is transparent in accordance with the wavelength range of the light source and of which the radius of curvature at break is at most 5 mm. For example, for the range of visible rays, the film may be formed of various polymers of acetate resins, polyester resins, polyether-sulfone resins, polycarbonate resins, polyamide resins, polyimide resins, polyolefin resins, acrylic resins, polyether resins, polyvinyl chloride, styrene resins, norbornene resins or the like, or other acrylic, urethane-type, acrylurethane-type, epoxy-type or silicone-type thermosetting or UV-curable resins. Preferably, the optical film is formed of a material of no or little birefringence.

The radius of curvature at break as mentioned hereinabove means the radius of curvature to which the optical film can be folded with no break, and this is an objective standard for flexibility. For preventing the film from being broken during adhesion treatment, for preventing it from receiving bubbles in the adhered interface, for reducing the film reworking frequency, for improving the continuous film adhesion treatment, for improving the film peelability in reworking and for preventing the cell substrate from being damaged or broken in reworking, it is desirable that the radius of curvature of the optical film at break is from 0.1 to 4 mm, more preferably from 1 to 3 mm.

The radius of curvature at break of the optical film is determined by the stiffness and other physical properties of the material to form the film and by the thickness of the film. Accordingly, the thickness of the optical film shall be suitably determined in accordance with the radius of curvature at break of the film. In general, from the balance of the thickness reduction and the side-light transmission efficiency, the film thickness may be from 50 to 1500 μm, preferably from 100 to 1000 μm, more preferably from 150 to 700 μm.

The optical film may be formed in any desired method of, for example, machine cutting. From its mass productivity, herein mentioned are some preferred methods of producing the optical film. One comprises pressing a thermoplastic resin against a mold having a predetermined shape under heat to thereby transfer the shape to the resulting resin film; another comprises filling a thermoplastic resin that has been melted under heat or a resin that has been fluidized via heat or solvent, into a mold having a predetermined shape; and still another comprises filling or casting a monomer, an oligomer or a liquid resin capable of polymerizing through exposure to heat, UV rays, or radiations, into a mold having a predetermined shape to thereby polymerize it. Above all, UV-curable resin is preferred for the optical film in view of the scratch resistance (hardness) and the production efficiency of the film.

Also employable is a method of applying the above-mentioned resin capable of polymerizing through exposure to UV rays or radiations, onto a support film, followed by molding and polymerizing the coating layer in a mold having a predetermined shape. In this case, a transparent support film may be used, and an optical film integrated with it may be produced. Alternatively, the optical film may be peeled from the support film, after formed thereon. In this, the optical film thus formed is the coating layer alone that has been molded through polymerization, and the support film to be used for it may not be a transparent film. For peeling the optical film from it, the support film may be surface-treated with a lubricant. For the transparent support film, usable are any resins that are mentioned hereinabove for the optical film.

The optical film may be processed for antiglare or antireflection or may also be processed to have a hard coat for scratch resistance improvement. The antiglare treatment maybe effected in various methods of roughening the film surface through sandblasting or embossing, or adding transparent grains such as silica to the film surface, or coating the film surface with transparent grains-containing resin, whereby the film surface may have a finely-roughened structure.

The antireflection treatment may be effected, for example, by forming an interfering vapor-deposition film on the film surface. On the other hand, the treatment for forming a hard coat on the film surface may be effected by coating the film surface with a hard film of a curable resin or the like. The antiglare treatment, the antireflection treatment and the hard coat film formation may also be applied to the case of film adhesion where the film has been processed for making its surface have a fine surface-roughed structure or for forming an interference film or a hard film on its surface.

In the embodiment of FIG. 1, the optical film is disposed on the view side of the liquid-crystal display panel. In this case, it is more desirable that the slopes-having face, or that is, the face with the light-emitting means A formed therein is disposed to be outside (on the view side) for better reflection efficiency via the optical path-changing slopes A1 of the light-emitting means A and even for higher brightness owing to the effective utilization of the side light to enter the panel. Also preferably, the optical film is airtightly fitted to the liquid-crystal display panel via an adhesive-layer or the like for higher brightness owing to the effective utilization of the side light or external light to enter the panel.

The adhesive layer may be formed of a suitable transparent adhesive, and the type of the adhesive is not specifically defined. Accordingly, an UV-curable adhesive may be employed. However, it is more desirable that the optical film is fitted to the panel in a mode of sticking via an adhesive layer, in view of the simplicity of the adhesion operation and of the reworkability of the fitted film. The adhesive layer may have a multi-layered structure of different adhesive layers for improving the stickiness thereof. For forming the adhesive layer, for example, employable is any adhesive agent that comprises a base polymer suitably selected from rubber polymers, acrylic polymers, vinyl alkyl ether polymers, silicone polymers, polyester polymers, polyurethane polymers, polyether polymers, polyamide polymers, styrene polymers, etc.

For the adhesion treatment, for example, employable is a continuous adhesion system where an optical film is adhered to an object while a columnar roll is made to follow it under pressure. The optical film is flexible and is therefore not cracked even when it is folded while the roll is made to follow it under pressure according to the method. However, ordinary light pipes are not flexible and therefore could not be processed through such continuous adhesion treatment.

In the embodiment of FIG. 1, a polarizing layer 25 is disposed between the optical film 40 and the view-side substrate 20. If desired, the polarizing layer may be disposed also between the backside substrate 10 and the reflection layer 13. The polarizing layer is for attaining better liquid-crystal display through optical control via polarization.

For forming the polarizing layer, any suitable material may be used with no specific limitation. Accordingly, for example, the polarizing film may be a coating film of a lyotropic liquid-crystalline dichromatic dye or a dichromatic dye-containing lyotropic substance, and may have a thickness of from about 0.1 to 20 μm or so (WO 94/28073 and WO 97/39380).

For obtaining better display having a higher contrast ratio that is attainable by more linearly-polarized light, preferred is a polarizing layer having a high degree of polarization. For the polarizing layer of the type, for example, usable is an absorption-type polarizing film formed by stretching a hydrophilic polymer film such as a polyvinyl alcohol film, a partially-formalized polyvinyl alcohol film, or a partially saponified, ethylene-vinyl acetate copolymer film that has absorbed iodine or a dichromatic substance such as a dichromatic dye, or such a absorption-type polarizing film further coated with a transparent protective layer on one or both surfaces thereof.

For forming the transparent protective layer, preferred is a material having high transparency, mechanical strength, thermal stability and water shieldability. For its examples, referred to are the polymers mentioned hereinabove for the optical film. The transparent protective layer may be attached to the film, for example, in a mode of lamination with film or coating with polymer solution. Accordingly, the optical film may be made to serve also as the transparent protective layer. The polarizing layer, especially that on the view side may be processed for antiglare or antireflection in the manner as above.

As in the embodiment of FIG. 1, a transparent layer 26 of which the refractive index is lower than that of the optical film 40 may be provided between the polarizing layer 25 and the optical film 40. One function of the transparent layer of which the refractive index is lower than that of the optical film is described. While the light which the optical film has received from the light source 51 runs through the optical film, the traveling light can be totally reflected on the transparent layer 26 owing to the refractivity difference between the transparent layer 26 and the optical film and is therefore efficiently enclosed inside the film, as shown by the zigzagging arrowed line β, whereby the traveling light can be efficiently transmitted backward to reach the position remoter from the light source and it can be uniformly supplied even to the optical path-changing slopes A1 positioned remoter from the light source, and, as a result, the brightness uniformity in the entire display panel is further increased owing to the change of the running direction of the reflected light.

Another function of the transparent layer of low-refractive-index is described. The transparent layer prevents the light that runs through the optical film from being absorbed, double-refracted or scattered by the polarizing layer 25 or the liquid-crystal layer 30 to be attenuated or irregularized, and prevents the display from being darkened. In addition, it further prevents ghost appearance in the backward side to worsen the display quality. Moreover, when a color filter or the like is disposed in the panel, the transparent layer is further effective for preventing rapid absorption of the running light by the color filter to thereby prevent the attenuation of the intensity of the running light.

The transparent layer of low-refractive-index may be formed of a suitable material of which the refractive index is lower than that of the optical film, such as an inorganic or organic dielectric substance of low-refractive-index. Briefly, the layer may be formed in any desired mode of vacuum evaporation or spin coating. The material and the method of forming it are not specifically defined. Accordingly, the adhesive layer or the adhesive layer for adhering the optical film to the panel may be made to serve also as the transparent layer. This embodiment is favorable for simplifying the constitutive layers of the panel.

In view of the transmission efficiency through the total reflection toward the backward, it is desirable that the refractive index difference between the transparent layer and the optical film is as large as possible. Concretely, the difference is preferably at least 0.05,more preferably at least 0.08, even more preferably from 0.1 to 0.5. The refractive index difference of this level has little influence on the display quality in external light mode operation. In this connection, when the refractive index difference is 0.1, the external light reflectivity at the interface between the transparent layer and the optical film is at most 0.1%, and the brightness or contract reduction owing to the reflection loss is extremely small.

Regarding the thickness of the transparent layer of low-refractive-index, if the layer is too thin, the light-enclosing effect mentioned above will lower owing to wave leakage through the thin layer. Therefore, for ensuring the total reflection effect thereof, the layer is preferably as thick as possible. The thickness of the layer may be suitably determined in consideration of the total reflection effect of the layer. In general, the thickness of the layer is defined in consideration of the total reflection effect thereof for the visible light having a wavelength of from 380 to 780 nm, especially for the short wavelength light of 380 nm, and concretely on the basis of the optical path length that is represented by (refractive index)×(layer thickness). Accordingly, it is desirable that the thickness of the layer is at least ¼ wavelength (95 nm), more preferably at least ½ wavelength (190 nm), even more preferably at lest one wavelength (380 nm).

Preferably, the thickness of the transparent layer of low-refractive-index is at least 600 nm. In case where the adhesive layer serves also as such a transparent layer of low-refractive-index, its thickness is generally from 1 to 200 μm, preferably from 5 to 100 μm, more preferably from 10 to 50 μm. The transparent layer of low-refractive-index is preferably as smooth as possible, as not scattering the light that runs though the panel and not having any influence on the display light.

As in the embodiment of FIG. 1, the liquid-crystal panel of the invention is a reflection-type one having a reflection layer 13 on the outer surface of the backside substrate 10. The function of the reflection layer 13 is described with reference to the zigzagging arrows α and γ in FIG. 1. The light which the optical film 40 has received from the light source 51 is reflected on the optical path-changing slope A1 and its traveling direction is changed toward the backside of the panel, then the light is again reflected and reversed on the reflection layer 13 to give the display light α in the mode driven by illumination; and the external light which the panel has received from the view-side thereof is reflected and reversed on the reflection layer 13 to give the display light γ in the mode driven by external light. In that manner, the reflection-type liquid-crystal display of the invention is driven both in external light and in illumination.

The reflection layer may be formed of a white sheet or the like in any ordinary manner. For it, especially preferred is a reflection layer of high reflectivity. It includes, for example, a coating layer formed of a metal or alloy powder of high reflectivity such as aluminium, silver, gold, copper or chromium mixed with a binder resin; a multi-layered film of the metal or a dielectric material formed in a film-forming method of vacuum vaporization, sputtering or the like; a reflection sheet of the coating layer or the multi-layered film held on a filmy support or the like; and a metal foil layer.

The reflection layer to be formed herein may have a light scattering function on its scattering and reflecting surface, the reflected light is scattered whereby the view angle of the display may be broadened. When the surface of the reflection layer is roughened, the Newton rings caused by layer adhesion can be prevented and the visibility of the display can be improved. Accordingly, the reflection layer to be disposed on the outer surface of the backside substrate may be merely overlaid or may be airtightly attached through adhesion or vapor deposition.

For forming such a light-scattering reflection layer, for example, a film substrate or the like is processed for roughing its surface through sand-blasting or matting or by adding fine grains thereto to thereby make its surface have a finely-roughened structure, and a reflection layer is formed on the film substrate to receive the finely-roughened structure from it. The finely-roughened structure-having reflection layer that has received the finely-roughed structure of the surface profile of the film substrate may be formed in any known manner, for example, by depositing metal on the surface of the film substrate through vapor deposition such as vacuum evaporation, ion plating or sputtering, or through plating.

In fabricating the liquid-crystal cell and the liquid-crystal display panel, if desired, one or more functional layers including, for example, an orientation film such as a rubbed film for liquid crystal orientation, and a color filter for color display may be provided therein. As in the embodiment illustrated, the orientation films 12 and 22 are generally formed to face the liquid crystal 30. The color filter is generally provided between one of the substrates 20, 10 and the transparent electrode. The transparent electrode to be fitted to the substrates 20, 10 may be formed of ITO or the like, in any ordinary manner.

The liquid-crystal display panel may have one or more suitable optical layers such as retardation layer and light diffusion layer attached to the liquid-crystal cell therein. The retardation layer is for improving the display quality of the panel through compensation for the retardation to be caused by the birefringence of the liquid crystal. The light diffusion layer is for enlarging the display range through diffusion of display light, for unifying the brightness by leveling the ray emission via the optical path-changing slopes of the optical film, and for increasing the quantity of light capable of entering the optical film by diffusing the light that runs through the cell substrate.

The retardation layer may be any suitable one, including, for example, a birefringent film prepared by stretching a film of a suitable polymer such as that mentioned hereinabove for the optical film, an oriented layer of a suitable liquid-crystalline polymer such as nematic or discotic liquid-crystalline polymer, or the oriented layer supported by a transparent substrate. Also usable for it is a thermal-shrinkage film of which the refractive index has been controlled in the thickness direction under the action of the thermal shrinking force thereof. For thinning the panel, preferred is the oriented layer of a liquid-crystalline polymer.

In general, the retardation layer for compensation is optionally disposed between the polarizing layer on the view side and/or on the backside and the liquid-crystal cell. The retardation layer may be any desired one, suitably selected depending on the wavelength range of the device. If desired, two or more layers may be laminated for the retardation layer for controlling the retardation and other optical properties of the panel.

On the other hand, the light diffusion layer may be formed also in any desired manner, for example, by forming the coating layer of which the surface has a finely-roughened structure like the above-mentioned antiglare layer, or by forming a diffusion sheet. If desired, the light diffusion layer may be formed as a layer that serves also as an adhesive layer with transparent grains incorporated therein, and the sticky light diffusion layer acts to fix the polarizing layer, etc. Accordingly, one or more such light diffusion layers may be disposed in any desired position between the liquid-crystal cell and the optical film.

For forming the above-mentioned adhesive layer, employable is any desired adhesive agent like that mentioned hereinabove. Especially preferred are those of good transparency, weather resistance and heat resistance, for example, acrylic sticky substances that comprise, as the base polymer, an alkyl acrylate or methacrylate-based polymer.

The transparent grains that may be in the adhesive layer or the adhesive layer may be one or more types of inorganic grains that may be electroconductive, such as silica, alumina, titania, zirconia, tin oxide, indium oxide, cadmium oxide or antimony oxide having a mean grain size of from 0.5 to 20 μm, or organic grains of crosslinked or non-crosslinked polymers, etc. The transparent grains may also be used in the antiglare treatment etc.

As in the embodiment of FIG. 1, the light source 51 that is disposed on the side of the optical film 40 is for introducing light into the optical film through its side face, and the thus-introduced light serves for illumination of the reflection-type liquid-crystal display. This forms a thin front-lith structure, with which the reflection-type liquid-crystal display of the invention may be thin and lightweight.

The light source may be so disposed that the light from it may enter the optical film through the side face of the film, as illustrated. Apart from this, in order to make the device receive light from the side of the view-side substrate and/or from the side of the backside substrate, the light source may also be disposed on the face of the optical film combined with the view-side substrate and/or on the face of liquid-crystal cell or the liquid-crystal panel combined with the backside substrate. In case where the light source is disposed on the face of the optical film combined with the view-side substrate, it is desirable that the side of the view-side substrate is made to protrude outside as compared with the side of the backside substrate in order that the light source may be mounted on the protruding face of the view-side substrate. Thus designed, the structure prevents the liquid-crystal layer from receiving light from the unit.

The light source may be any desired one. For example, preferred are linear light sources such as (cold, hot) cathode-ray tubes, point light sources such as light-emitting diodes; their linear or two-dimensional arrays; and other light sources that comprise point light sources and linear light pipes, in which the light emitted by the point light sources is converted into linear light sources via the liner light pipes.

One or more light sources 51 may be disposed on the side of the optical film, etc. In case where two or more light sources are disposed on different sides, the sides may be opposite to each other, or may cross each other in the vertical and horizontal directions, or maybe disposed on three or more sides in a manner of combination of the former two modes. Preferably, the light source faces the optical path-changing slopes of the optical film for improving the incident efficiency of the light from the side light source and the light running through the optical film into the optical path-changing slopes of the film and for improving the brightness of the panel.

When put on, the light source enables the image visibility in a mode of illumination. Therefore, it is unnecessary to put on the light source while the panel is seen in a mode of external light. Accordingly, the light source shall be switched on and off. For it, any desired switching mechanism maybe employed, and it may be any conventional one. If desired, the light source may be a multi-color emitting one capable of emitting different colors by switching, or different types of light sources may be disposed in the device to emit different colors.

As in the embodiment illustrated herein, the light source 51 may be optionally provided with any desired auxiliary parts such as a reflector 52 that surrounds it. The reflector acts to lead the diffused light toward the side of the optical film, etc. For the reflector, for example, used is a suitable reflection sheet capable of at least reflecting the light from the light source. For example, it may be a resin sheet with a thin metal film of high reflectivity attached thereto, or a white sheet or metal foil. The edges of the reflector may be attached to the upper and lower edges of the optical film, etc., and it may serve also as a holding unit (light source holder) that surrounds the light source.

In the reflection-type liquid-crystal display of the invention, the light from the light incident surface of the device enters the device through the optical film, then reflected according to the refraction law and transmitted backward, while the light emission (leakage) through the surface is prevented, and the light having reached the optical path-changing slopes A1 is efficiently reflected thereon to change its traveling direction toward the backside with good vertical orientation.

The other light running through the device is totally reflected to further run backward, and, when having reached the optical path-changing slopes A1 in the backward area, it is also efficiently reflected thereon to change its traveling direction toward the backside with good vertical orientation. As a result, the device attains good display, and especially when the transparent layer of low-refractive-index is disposed therein, it attains bright and uniform display on the entire surface of the display panel. Accordingly, the device efficiently utilizes the light from the light source and the external light, and gives bright and high-quality display easy to see. Having the advantages, the invention provides the reflection-type liquid-crystal display for use both in external light and in illumination.

In the invention, the optical elements and parts such as the optical film, the liquid-crystal cell, the polarizing layer and the retardation layer that constitute the reflection-type liquid-crystal display may be wholly or partly fitted to each other through lamination and integration, or may be disposed in a readily detachable condition. For preventing contrast reduction owing to interfacial reflection, it is desirable that the constitutive components are fitted to each other.

For fitting and attaching the components to each other, usable is a suitable transparent adhesive such as an adhesive agent. Transparent grains such as those mentioned above may be added to the transparent adhesive layer so that the layer may serve for light diffusion. If desired, the above-mentioned optical elements and parts, especially those on the view side of the device may be processed with an UV-absorbent of, for example, salicylate compounds, benzophenone compounds, benzotriazole compounds, cyanoacrylate compounds or nickel complex compounds, for making them have UV absorbability.

### EXAMPLE 1

A non-oriented polycarbonate film having a refractive index of 1.58 was coated with an UV-curable acrylic resin (Toa Gosei's Aronix UV-3701), airtightly attached to a mold that had been previously worked to have a predetermined shape, via a rubber roller, whereby excess resin and bubbles were removed. Then, this was cured through exposure to UV rays from a metal halide lamp, and then released from the mold. Further, the polycarbonate film was peeled, and an optical film having a refractive index of 1.52 and a thickness of 0.2 mm was obtained. The process was effected continuously.

The optical film has light-emitting means irregularly distributed in its surface in such a manner that their distribution density gradually increases remoter from the light incident surface thereof. In this, each light-emitting part is composed of an optical path-changing slope having an inclination angle of about 42 degrees and a steep slope having an inclination angle of about 65 degrees, and its cross-section profile is a triangular recess having a length of 80 μm and a width of 10 μm. The area of the flat part between the neighboring light-emitting means is about 10 times that of the light-emitting part.

### EXAMPLE 2

An optical film was fabricated in the same manner as in Example 1, which, however, has a thickness of 0.5 mm.

### EXAMPLE 3

An optical film was fabricated in the same manner as in Example 1, which, however, has a thickness of 1.0 mm.

### EXAMPLE 4

An optical film was fabricated in the same manner as in Example 1, which, however, has a thickness of 1.5 mm.

### EXAMPLE 5

An optical film having a thickness of 1.0 mm and having the same light-emitting means as in Example 1 was fabricated, according to an injection-molding method of using an acrylic resin.

### Evaluation Test

Each optical film having a size of 20 mm x 50 mm obtained in Examples 1 to 5 was made to receive a flexural load, and its radius of curvature at break was measured. This is the radius of curvature at break of the tested film. On the other hand, the optical film was continuously adhered to a polarizing plate via an adhesive layer while a columnar roller having a diameter of 50 mm was made to follow the optical film under pressure, whereupon the film was checked for cracks for evaluating its flexibility and for bubbles that followed it (to enter the interface) for evaluating its adhesion workability. The samples with no cracks are A: those with some cracks are B; and those completely broken are C. The samples with few bubbles are A; those with some bubbles are B; and those with many bubbles are C.

The results are given in the following Table.

| | Ex. 1 | Ex. 2 | Ex. 3 | Ex. 4 | Ex. 5 |
|---|---|---|---|---|---|
| Radius of Curvature at | 2 | 3 | 10 | 30 | 50 |
| break (mm) | | | | | |
| Flexibility | A | A | B | C | C |
| Adhesiveness | A | A | B | C | C |

A polarizing plate (Nitto Denko's NPF EGW1225DU) was adhered to the view side of a commercially-available TN-type liquid-crystal cell, via an adhesive layer, and then the optical film of Example 1 or 2 was adhered thereonto via an acrylic adhesive layer (transparent layer of low-refractive-index) having a thickness of 20 μm and a refractive index of 1.47. In addition, a reflector plate was adhered to the back side of the structure to obtain a reflection-type liquid-crystal panel. A cold cathode-ray tube was disposed on the side of the optical film including the view-side substrate, and this was surrounded by a silver-deposited polyester film. The edges of the film were adhered to the upper and lower sides of the device with a double-adhesive tape so that the cold cathode-ray tube was tightly fixed to the device to prevent light leakage. The process gave a reflection-type liquid-crystal display for use both in external use and in illumination.

Thus fabricated, the reflection-type liquid-crystal display was tested in a dark room. Its cold cathode-ray tube was switched on with no voltage applied to the liquid-crystal cell, and the display gave bright and uniform light. On the other hand, the cold cathode-ray tube therein was not switched on, and the device was tested in a mode of external light operation. The device also gave bright and uniform light, and its display quality was good.

As described hereinabove, it is understood that the present invention has attained a thin and lightweight, reflection-type liquid-crystal display for use both in external light and in illumination. It comprises a light pipe to prevent it from being bulky and heavy, and comprises a light source on its side to enable light emission. Further, it comprises an optical film to realize thin and lightweight device. Thus constructed, the device ensures high-quality display. Further, since the optical film in the device is flexible, it is not broken and takes few bubbles while adhered to the panel. Accordingly, it is understood that the workability, the productivity and even the reworkability of the device are all good.

What is claimed is:

1. A reflection-type liquid-crystal display comprising:
a transparent view-side substrate with a transparent electrode and a transparent backside substrate with a transparent electrode that are so combined as to have a liquid crystal between the facing electrodes thereof to construct a liquid-crystal cell;
a transparent optical film having a radius of curvature at break of at most 5 mm, on an outer side of the view-side substrate via a polarizing layer therebetween;
a reflection layer on an outer side of the backside substrate; and
at least one light source disposed on one or more sides of the optical film,
wherein the optical film has, in its surface, a plurality of optical path-changing slopes that incline at an angle of from 35 to 48 degrees relative to a standard plane of the view-side substrate.

2. A reflection-type liquid-crystal display according to claim 1, which has, between the polarizing layer and the optical film, a transparent layer of which the refractive index is lower than that of the optical film.

3. A reflection-type liquid-crystal display according to claim 1, wherein the optical path-changing slopes of the optical film are formed to have a prismatic cross-sectional profile, and face the light source.

4. A reflection-type liquid-crystal display according to claim 1, wherein the prismatically-formed optical path-changing slopes of the optical film have a cross-sectional profile of a triangular recess.

5. A reflection-type liquid-crystal display according to claim 4, wherein the recesses are parallel to or inclined relative to the side of the device with the light source disposed thereon, and form continuous grooves that extend from one end to the other end of the optical film.

6. A reflection-type liquid-crystal display according to claim 4, wherein the recesses are discontinuous grooves and are disposed irregularly, and the length of the groove is at least 5 times the depth thereof.

7. An optical film of a transparent film, which has, in one surface thereof, a plurality of recesses of which the cross section is triangular and has an optical path-changing slope having an inclination angle relative to the film plane of from 35 to 48 degrees, and which has a radius of curvature at break of at most 5 mm.

8. An optical film according to claim 7, which is a transparent film of a UV-curable resin having a thickness of from 100 to 1500 μm and having a radius of curvature at break of at most 3 mm, or a transparent film having a UV-curable resin layer formed on a transparent support film, having a thickness of from 100 to 1500 μm and having a radius of curvature at break of at most 3 mm.
